(19) United States
(12) Patent Application Publication
(10) Pub. No.: US 2026/0300490 A1
(43) Pub. Date: Oct. 1, 2026

(54) PORTABLE PROOF OF VERIFICATION TO GATE LOADING OF CODE AT RUNTIME

(71) Applicant: MICROSOFT TECHNOLOGY LICENSING, LLC, Redmond, WA (US)

(72) Inventors: Shankar SEAL, Bothell, WA (US); Alan Thomas Gavin JOWETT, Rathdrum, ID (US)

(21) Appl. No.: 19/096,543

(22) Filed: Mar. 31, 2025

(51) Int. Cl. G06F 21/57

(52) U.S. Cl. CPC G06F 21/57

(57) ABSTRACT

The techniques disclosed herein enable systems to provide a portable proof of verification that enables an external entity (e.g., a consumer) to examine the safety of the computer program. In general, the external entity does not have access to prior representations of a computer program (e.g., source code). Consequently, the external entity that receives a final executable version of a computer program (e.g., a native image) may be unable to verify its safety using standard tools such as static analysis. Accordingly, the present system implements a build pipeline that includes a certificate signature with a native image attesting that the computer program is safe to execute. The build pipeline includes the certificate signature if and only if the computer program passes a safety verification during compilation. In this way, the holder of the certificate signature can verify the safety of the computer program prior to loading and execution.

### BACKGROUND

In computer science and software engineering, static analysis (also known as static program analysis) is an evaluation of a computer program that is performed without executing the computer program. In general, the term static analysis refers to analysis that is performed by an automated tool, as opposed to human analysis (e.g., "program understanding"). As such, the sophistication and complexity of a static analysis tool can vary greatly, from tools that evaluate the behavior of individual statements (e.g., instructions) to tools that model the full behavior of a computer program with respect to its source code. Consequently, static analysis tools can be utilized in a wide variety of technical contexts from detecting simple coding errors to mathematically proving various properties about a given computer program.

Many modern software systems rely upon static analysis tools to verify the safety and/or correctness of computer programs prior to execution. The static analysis tool identifies a given computer program as either safe for execution or unsafe for execution. However, not all representations of a computer program are amenable to static analysis. For instance, it may not be feasible to perform static analysis on a final executable version of a computer program comprising machine code. Conversely, a prior state of the program (e.g., prior to compilation) may be much more amenable to static analysis. Therefore, an external entity that receives the final executable version of a computer program (e.g., a consumer) may not be able to verify the safety of a given program, and this presents potential security and/or functionality concerns when executing computer programs. This is especially true for software systems operating in a privileged context (e.g., an operating system kernel) and/or safety-critical systems (e.g., medical software, aviation software).

It is with respect to these and other considerations that the disclosure made herein is presented.

### SUMMARY

The techniques presented herein are directed to a system that provides a portable proof of verification that enables an external entity (e.g., a consumer) to examine the safety of the computer program. In general, the external entity is separate and different from a provider of the computer program (e.g., a developer) and thus does not have access to prior representations of a computer program (e.g., source code).

In existing arrangements that do not utilize the techniques presented herein, the external entity that receives a final executable version of a computer program may be unable to verify its safety using standard tools such as static analysis. Within the context of the present disclosure, a static analysis tool is an automated software tool that evaluates the behavior of a given computer program without executing the computer program and can classify computer programs as safe to execute or not safe to execute. As such, a computer program is said to be “verified” in response to a static analysis tool classifying the computer program as safe to execute.

However, as mentioned above, not all representations of a computer program are amenable to static analysis. For instance, it may not be feasible to perform static analysis on a final executable version of a computer program comprising machine code instructions due to the large number of instructions and opaque semantics. Conversely, a prior state of the program (e.g., source code prior to compilation) may be much more amenable to static analysis due to its well-defined semantics and structure. Consequently, external entities that typically only have access to the final executable version of a computer program may not be able to verify the computer program. Stated another way, the external entity must trust the provider of the computer program regarding the safety of the computer program. Unfortunately, such an approach to safety and security may be insufficient for external entities that operate large-scale and/or safety-critical computer systems and/or computer programs that operate in privileged environments such as an operating system kernel.

To that end, the system presented herein provides mechanisms for external entities (e.g., consumers) to verify a computer program prior to execution using a portable proof of verification. Generally described, a provider of a computer program, referred to herein as a responsible entity (e.g., a developer), submits the computer program to a build pipeline for verification and compilation. Accordingly, the portable proof of verification is generated and applied to the computer program by the build pipeline. In various examples, the computer program submitted by the responsible entity is a human-readable representation (e.g., source code) that is formatted in accordance with a standardized programming language such as C++ and PYTHON.

As part of the compilation process, the computer program can be translated into an intermediate representation comprising a sequence of instructions. For instance, in the case of PYTHON, the source code is translated into a sequence of bytecode instructions. The sequence of instructions is then analyzed by a statis analysis tool that verifies whether the computer program is safe to execute. That is, the static analysis tool classifies the computer program as either safe to execute or unsafe to execute. In various examples, a computer program is said to be safe to execute if the sequence of instructions does not attempt to perform operations that would cause an error, instability, or otherwise compromise a computing system that is executing the computer program.

In response to classifying the program as safe to execute, the build pipeline compiles the intermediate representation of the computer program into a native image comprising a final executable version of the computer program. In addition, the build pipeline signs the native image with a certificate signature representing the proof of verification if and only if the computer program was verified as safe by the static analysis tool. In various examples, signing the native image involves the use of an asymmetric key pair, referred to as a private key and a public key. The private key is secret, only known by the party to whom the certificate is issued (e.g., the build pipeline). As such, signing the native image can comprise generating a cryptographic hash of the data within the native image and then encrypting the cryptographic hash using the private key. Moreover, the signed certificate can include information about an entity to whom the certificate was issued, an entity that issued the certificate, what purpose the certificate can be used for, a public key corresponding to the private key and numerous other pieces of information.

Consequently, an external entity that receives the native image and the certificate can use the public key corresponding to the private key to decrypt the certificate signature and obtain the cryptographic hash of the native image. To verify the certificate signature, the external entity then independently computes the cryptographic hash of the data within the native image. If the hash obtained from decrypting the certificate signature and the independently computed hash match, then the signature is demonstrably valid, and the data within the native image is unmodified. Furthermore, there may be a chain of certificates wherein a first certificate is signed by a second certificate, which in turn is signed by a third certificate. This chain of certificates must lead to a certificate that the external entity already trusts (e.g., a root of trust). Therefore, the external entity can verify the safety of the computer program without re-execution of the static analysis tool. Accordingly, an external machine can check for the presence and validity of the certificate signature as a criterion for loading and executing the computer program. Consequently, in one example of the technical benefit of the present disclosure, its inclusion in the native image of the computer program renders the certificate signature fully portable.

In another example of the technical benefit of the present disclosure, including a certificate signature representing a portable proof of verification improves the efficiency of computing systems executing the computer program. For instance, consider a system in which computer program code is compiled and then executed immediately thereafter, oftentimes referred to as just-in-time compilation. Consequently, such a system must execute a static analysis tool to verify the computer program each time the computer program is executed. This verification process can incur significant computational demand, thereby increasing computing costs (e.g., processing cycles). Conversely, consider a system in which computer program code is compiled into a native image prior to execution, oftentimes referred to as ahead-of-time compilation.

As such, an ahead-of-time system can verify the computer program at this stage thereby frontloading the time cost and streamlining program execution at runtime. Utilizing a portable proof of verification in the form of a certificate signature further streamlines an ahead-of-time system as the static analysis needs only to be executed once for a given program. Accordingly, the certificate signature is valid so long as the computer program (e.g., the native image) remains unmodified.

In still another example of the technical benefit of the present disclosure, utilizing a certificate signature enhances the security of computing systems. In various examples, the internal structure of the build pipeline is inaccessible to those that submit programs for compilation. Consequently, a responsible entity (e.g., a developer) that writes a computer program cannot themselves apply the certificate signature verifying the safety of the computer program. In this way, the certificate signature is resistant to malicious actors that may attempt to disguise an unsafe computer program with a valid certificate signature. Likewise, the certificate signature can be configured to be immediately invalidated upon any modification to the computer program thus requiring resubmission to the build pipeline and reverification by the static analysis tool.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a build pipeline for verifying the safety of a computer program and applying a certificate signature.

FIG. 2 illustrates an example of an external machine verifying the presence and validity of a certificate signature prior to loading and executing a computer program.

FIG. 3 illustrates an example of a certificate signature being invalidated in response to a modification of the associated computer program.

FIG. 4 is a block diagram illustrating additional technical details regarding a certificate signature.

FIG. 5 is a flow diagram showing aspects of a process for compiling and verifying a computer program to apply a certificate signature.

FIG. 6 is a computer architecture diagram illustrating an illustrative computer hardware and software architecture for a computing system capable of implementing aspects of the techniques and technologies presented herein.

### DETAILED DESCRIPTION

The techniques presented herein provide a system for generating a portable proof of verification that enables an external entity (e.g., a consumer) to examine the safety of the computer program prior to execution (e.g., runtime). In general, the external entity is separate and different from a provider of the computer program (e.g., a developer) and thus does not have access to prior representations of a computer program (e.g., source code). As such, in conventional arrangements, the external entity that receives a final executable version of a computer program may be unable to verify its safety using standard tools such as static analysis. Within the context of the present disclosure, a static analysis tool is an automated software tool that evaluates the behavior of a given computer program without executing the computer program and can classify computer programs as safe to execute or not safe to execute. As such, a computer program is said to be “verified” in response to a static analysis tool classifying the computer program as safe to execute.

As mentioned above, signing the native image involves the use of an asymmetric key pair, referred to as a private key and a public key in a public key cryptography system. The private key is secret, only known by the party to whom the certificate is issued (e.g., the build pipeline). As such, signing the native image can comprise generating a cryptographic hash of the data within the native image and then encrypting the cryptographic hash using the private key. Moreover, the signed certificate can include information about an entity to whom the certificate was issued, an entity that issued the certificate, what purpose the certificate can be used for, a public key corresponding to the private key and numerous other pieces of information. Examples of algorithms for computing cryptographic hashes include Secure Hash Algorithm 2 (SHA-2) and the Message-Digest Algorithm. Examples of public key cryptography systems include Elliptic-curve cryptography (ECC) and the Rivest–Shamir–Adleman (RSA) algorithm.

Consequently, an external entity that receives the native image and the certificate can use the public key corresponding to the private key to decrypt the certificate signature and obtain the cryptographic hash of the native image. To verify the certificate signature, the external entity then independently computes the cryptographic hash of the data within the native image. If the hash obtained from the certificate signature and the independently computed hash match, then the signature is demonstrably valid, and the data within the native image is unmodified.

Furthermore, there may be a chain of certificates wherein a first certificate is signed by a second certificate, which in turn is signed by a third certificate. This chain of certificates must lead to a certificate that the external entity already trusts (e.g., a root of trust). Therefore, the external entity can verify the safety of the computer program without re-execution of the static analysis tool.

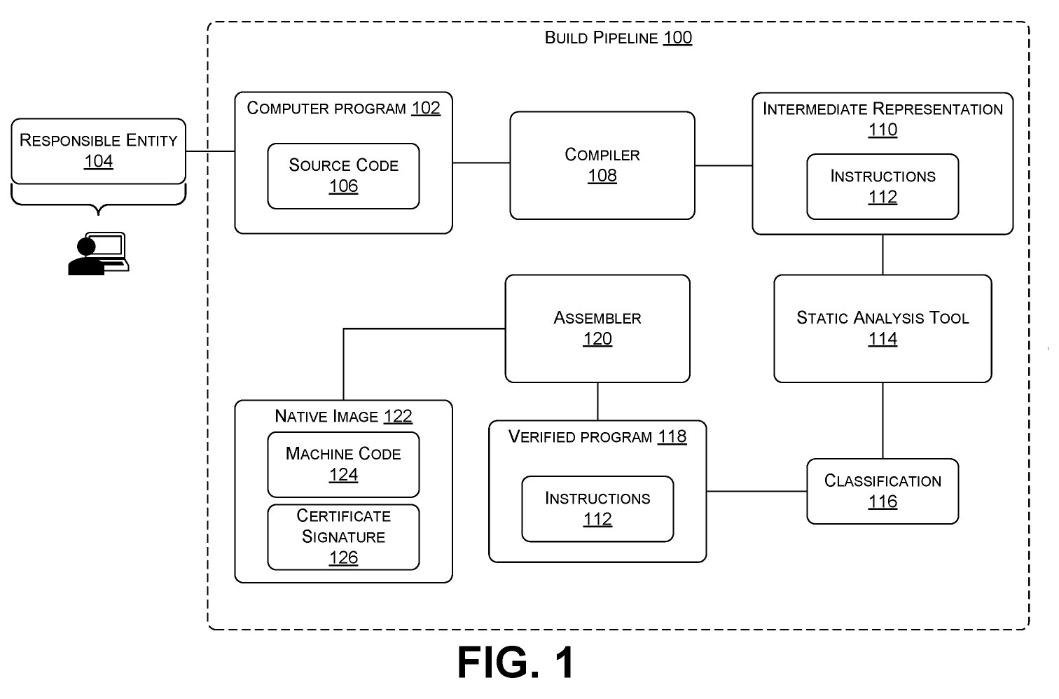

Various examples, scenarios, and aspects related to the techniques are described below with respect to FIGS. 1-6.

FIG. 1 illustrates a build pipeline 100 that receives a computer program 102 from a responsible entity 104 associated with the computer program 102 (e.g., a developer, a system administrator, a technician). In various examples, the computer program 102 comprises source code 106. Generally described, source code is a sequence of computer instructions written by a programmer in a high-level language that is human readable such as C, C++, PYTHON, and the like. Accordingly, the computer program 102 is input to a compiler 108 which translates the computer program 102 into an intermediate representation 110 comprising a sequence of instructions 112. In a specific example, the computer program 102 comprises source code 106 that is written in the C++ programming language. As such, the intermediate representation 110 comprises a sequence of assembly code instructions 112.

Subsequently, the intermediate representation 110 is processed by a static analysis tool 114 to verify the safety of the computer program 102. As mentioned above, a safe computer program 102 is a program that does not attempt operations that cause an error, instability, or otherwise compromise the computing system executing the computer program 102. As such, it should be understood that while all malicious programs are unsafe programs, not all unsafe programs are necessarily malicious programs. In addition, it should also be noted that, in some examples, the computer program 102 may already be formatted as a sequence of instructions on which the build pipeline 100 can execute the static analysis tool 114 (e.g., BPF bytecode). That is, the computer program 102 may forgo translation into the intermediate representation 110. Examples of static analysis tools include PREVAIL, CLANG, and SEMGREP.

Accordingly, the static analysis tool 114 generates a classification 116 of the intermediate representation 110 verifying whether the computer program 102 is a safe program or an unsafe program. In the present example, the classification 116 indicates that the computer program 102 is a safe program resulting in a verified program 118 comprising the instructions 112. At this stage, the verified program 118 is provided to an assembler 120 which generates a native image 122 of the computer program 102. In contrast to the computer program 102 which comprises human-readable source code 106, the native image 122 comprises machine code 124 that causes a computing system to perform the operations defined by the computer program 102. It should be understood that the use of an assembler 120 is specific to the example illustrated in FIG. 1 and that any suitable tool can be utilized to generate a native image 122 from a verified program 118.

In addition, the build pipeline 100 includes a certificate signature 126 with the native image 122 attesting that the native image 122 represents the verified program 118 and is safe to execute. As such, the certificate signature 126 is included with the native image 122 if and only if the computer program 102 was verified by the static analysis tool 114 as safe to execute. For security, the certificate signature 126 comprises a public cryptographic key that is bound to (e.g., signed by) an identity (e.g., a hostname, an organization, an individual) associated with the responsible entity 104. As such, an external entity configured with the certificate signature 126 can use the contained public cryptographic key to validate the computer program 102 wherein the certificate signature 126 was digitally signed by the corresponding private key. In a specific example, the certificate signature 126 is configured in accordance with a technical standard such as the International Telecommunication Union standard X.509.

As mentioned above, it is typically infeasible to perform static analysis on machine code 124 to verify safety. Moreover, an external entity receiving the native image 122 for execution may not have access to the source code 106 and/or the intermediate representation 110 to verify the safety of the computer program 102. Therefore, by including the certificate signature 126, the build pipeline 100 enables the external entity configured with the certificate signature to verify the safety of the computer program 102 without re-execution of the static analysis tool 114 and/or requiring access to the original source code 106.

In addition, to further ensure the integrity of the certificate signature 126, the internal structure of the build pipeline 100 and the certificate signature 126 are inaccessible to those that submit programs for compilation. Stated another way, the responsible entity 104 that submitted the computer program 102 cannot themselves apply and/or otherwise modify the certificate signature 126 verifying the safety of the computer program 102. In various examples, access to the internal structure of the build pipeline 100 is restricted by installing the build pipeline 100 as a pre-compiled software package (e.g., an executable file). Consequently, the responsible entity 104 that submitted the computer program 102 cannot access the source code of the build pipeline 100. Moreover, the integrity of the certificate signature 126 is ensured by restricting access to the private key associated with the certificate. That is, only entities (e.g., the build pipeline 100) have access to the private key and hence only the build pipeline can generate a valid signed hash of the program. In this way, the certificate signature 126 is resistant to malicious actors that may attempt to disguise an unsafe computer program 102 with a valid certificate signature 126.

Likewise, the certificate signature 126 can be configured to be immediately invalidated upon any modification to the computer program 102 thus requiring resubmission to the build pipeline 100 and reverification by the static analysis tool 114. In various examples, a change to the computer program 102 can comprise an edit to the source code (e.g., in a text editor, in a development environment), merging a change (e.g., in a version control system, in a software repository), and the like. As mentioned above, the certificate signature 126 is a cryptographic hash of the native image 122 that is computed from the machine code 124 to be executed that is then signed using the private key. Consequently, any changes to the machine code 124 will result in a different hash, which would then invalidate the signature. Moreover, invalidating the certificate signature 126 can comprise enabling or disabling a validity flag within the certificate signature 126, editing an entry in a certificate management authority system to revoke the certificate signature 126, or any other suitable method for invalidation.

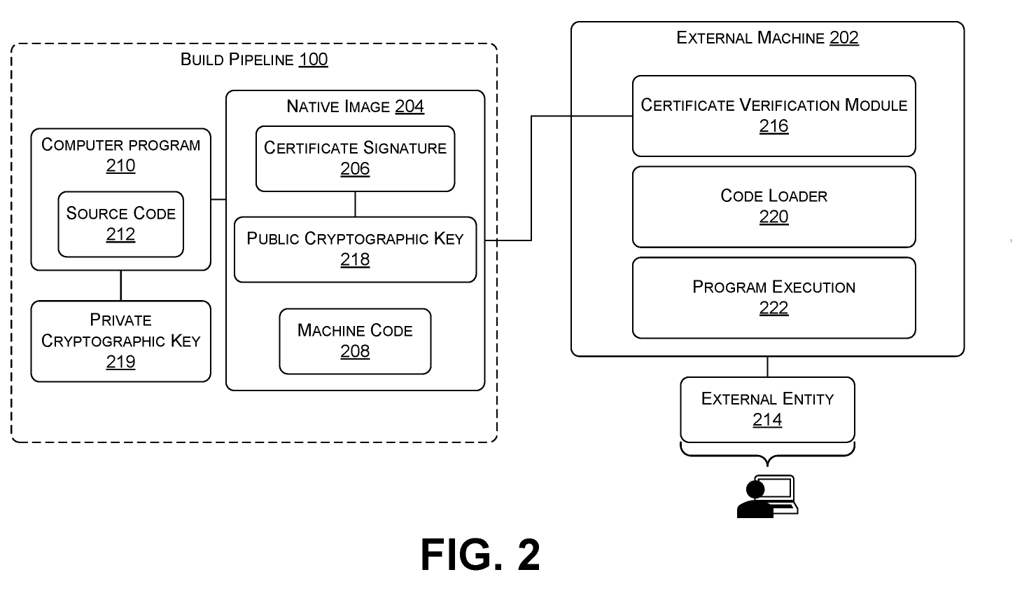

Turning now to FIG. 2, an example of an external machine 202 verifying a native image 204 by checking an included certificate signature 206 is shown and described. Similar to the example described above with respect to FIG. 1, a build pipeline 100 generates a native image 204 comprising machine code 208 from a computer program 210 comprising human-readable source code 212. In addition, the build pipeline 100 includes a certificate signature 206 with the native image 204, where the certificate signature 206 attests that the computer program 210 was verified as safe to execute by a static analysis tool. As mentioned above, the certificate signature 206 cannot be modified by a responsible entity (e.g., a developer) associated with the computer program 210 as the responsible entity cannot access the associated private key. That is, the certificate signature 206 cannot be applied and/or otherwise modified by entities outside of the build pipeline 100 thereby ensuring the integrity of the certificate signature 206.

Accordingly, an external machine 202 associated with an external entity 214 (e.g., a user, a consumer) can receive the native image 204 for execution. In various examples, the external machine 202 receives the native image 204 as part of a software deployment (e.g., a cloud computing environment), a software licensing purchase, and so forth. That is, the external machine 202 and/or the external entity 214 do not have access to the original source code 212 of the computer program 210. As mentioned above, the machine code 208 of the native image 204 may not be amenable to static analysis methods for verifying the safety of the computer program 210.

Consequently, the external machine 202 and/or the external entity 214 cannot independently verify the safety of the native image 204 prior to execution with a static analysis tool of their own. As such, the external machine 202 is configured with a certificate verification module 216 that checks the native image 204 for a valid certificate signature 206. Accordingly, the certificate verification module 216 retrieves a public cryptographic key 218 from the certificate signature 206 to verify the certificate signature using standard public key cryptography methods. As mentioned above, the certificate signature 206 is generated by computing a cryptographic hash of the data within the native image 204 (e.g., the machine code 208) and then encrypting the hash using a private cryptographic key 219 that corresponds to the public cryptographic key 218.

In various examples, verifying the certificate signature 206 comprises decrypting the certificate signature 206 using the public cryptographic key 218 to obtain a hash of the data within the native image 204 (e.g., the machine code 208). The certificate verification module 216 then independently computes a cryptographic hash of the data within the native image 204. If the hash obtained from decrypting the certificate signature and the independently computed hash match, then the certificate signature 206 is demonstrably valid, and the data within the native image 204 is unmodified. The certificate verification module 216 can then verify the identity that is bound to the certificate signature 206 as well as verify data extracted from the various fields of the certificate signature 206. Stated another way, the certificate verification module 216 ensures that the certificate signature 206 (1) is issued by a known trusted entity and (2) has not been tampered with.

In response to verifying the certificate signature 206, the native image 204 can then be prepared for execution by a code loader 220. Generally described, the code loader 220 is a component of the external machine 202 that is responsible for staging machine code 208 for execution 222. As such, in the present example, the code loader 220 can be gated from loading the machine code 208 of the native image 204 until after the certificate verification module 216 has verified the certificate signature 206. In this way, the certificate verification module 216 prevents the loading of unverified code thereby enhancing the security of the external machine 202.

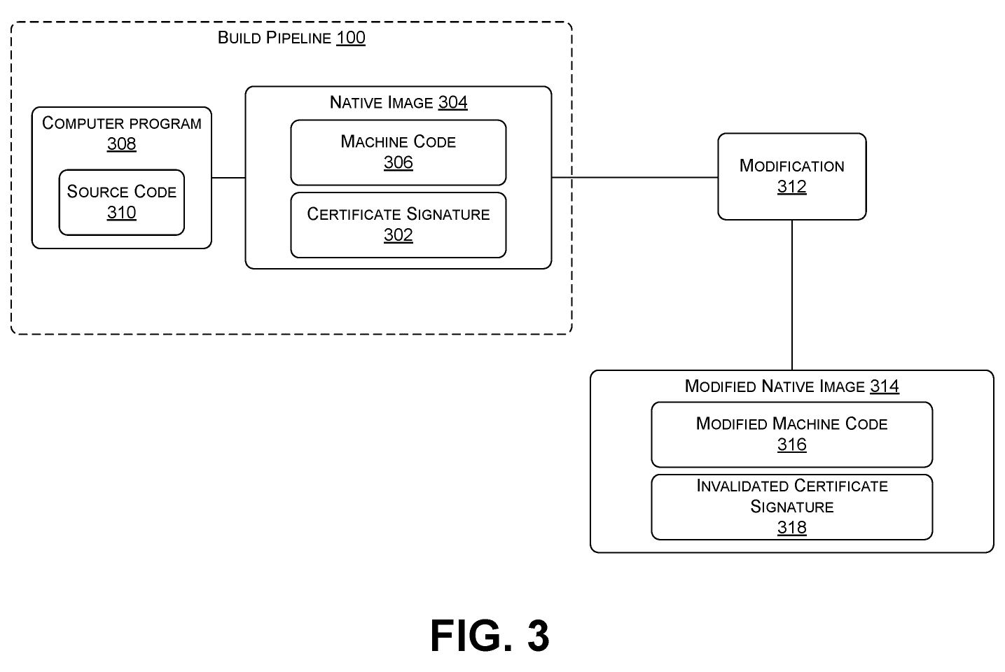

Proceeding now to FIG. 3, an example of invalidating a certification signature 302 in response to a modification to a native image 304 is shown and described. As mentioned above, the build pipeline 100 generates the native image 304 comprising machine code 306 from a computer program 308 comprising human-readable source code 310. Accordingly, build pipeline 100 includes a certificate signature 302 with the native image 304 to attest that the native image 304 is safe to execute. As mentioned above, the certificate signature 302 is a piece of data that is generated at the build pipeline 100 by generating a cryptographic hash of the data within the native image (e.g., the machine code 306) and then encrypting the cryptographic hash using a private key that is known only to the build pipeline 100. At a subsequent point in time, the native image 304 undergoes a modification 312 that changes some aspect of the machine code 306 resulting in a modified native image 314 comprising modified machine code 316.

The modification 312 can be detected by identifying a mismatch between the cryptographic hash that is obtained by decrypting the invalidated certificate signature 318 and a cryptographic hash that is independently computed from the modified machine code 316. In various examples, the modification 312 can be a malicious modification that aims to alter the functionality of the native image 304. That is, a malicious entity may attempt to hijack the certificate signature 302 to bypass certificate verification mechanisms such as those described above with respect to FIG. 2. In response to the identification of the modification 312, the certificate signature 302 is configured to become an invalidated certificate signature 318. As discussed above, invalidating a certificate signature 318 can include enabling or disabling a validity flag within the certificate signature 126, editing an entry in a certificate management authority system to revoke the certificate signature 126, or any other suitable method for invalidation. Consequently, if an external machine attempts to execute the modified native image 314, the invalidated certificate signature 318 will restrict the modified machine code 316 from being loaded thus preventing execution of unverified and/or potentially unsafe computer programs.

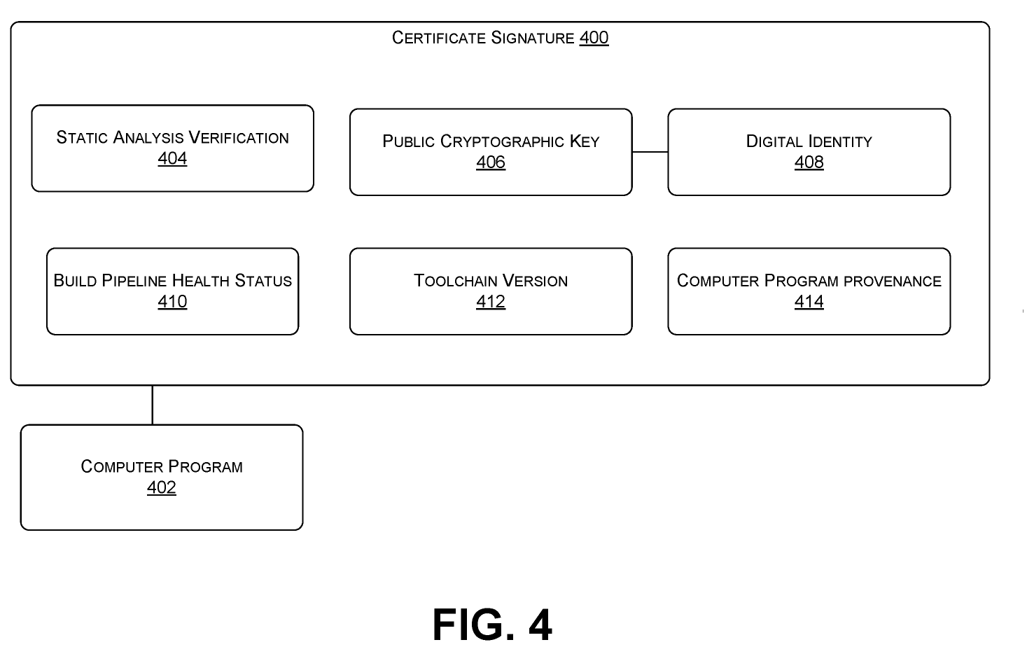

Turning now to FIG. 4, additional details of an individual certificate signature 400 are shown and described. As described above, the certificate signature 400 attests that an associated computer program 402 underwent a static analysis verification 404 that ensures the computer program 402 is safe to execute. To maintain the integrity of this attestation, the certification signature 400 includes a public cryptographic key 406 that is bound to a digital identity 408 (e.g., a digital signature) that identifies a responsible entity associated with the computer program 402 such as a hostname, an organization, an individual developer, and so forth. In this way, a holder of the certificate signature 400 can validate that the certificate signature 400 originates from a known and/or trusted entity.

As such, the holder can trust that the information presented in the certificate signature 400 is accurate. Consequently, the certificate signature 400 can be extended to include further information in addition to the static analysis verification 404. For instance, the certificate signature 400 includes a build pipeline health status 410. In various examples, the build pipeline health status 410 indicates that the environment in which the computer program 402 was compiled (e.g., the build pipeline 100) was operating correctly and that no errors occurred.

In another example, the certificate signature 400 specifies a toolchain version 412 that was utilized to build the computer program 402. The toolchain version 412 specifies the software components that were utilized to build the computer program 402 (e.g., a compiler, a linker, an assembler). In this way, a holder of the certificate signature 400 can verify the type of tools that built the computer program 402 and apply policies accordingly. For instance, consider a computing environment that, for various reasons, cannot execute computer programs 402 built using specific tools and/or specific versions of a tool (e.g., a compiler, a linker). As such, an operator of the computing environment can apply a policy that refers to the toolchain version 412 to prevent such computer programs 402 from being loaded even if the certificate signature 400 is valid. In another example, the toolchain version 412 enables the holder of the certificate signature 400 to verify that the correct version of a static analysis tool was utilized to verify the computer program 402.

In still another example, the certificate signature 400 includes information regarding the provenance 414 of the computer program 402. Generally described, the computer program provenance 414 includes metainformation regarding the origin of the computer program 402 (e.g., where the computer program comes from, identifications of developers that wrote the computer program) and how the computer program 402 has been altered over time (e.g., a changelog). By establishing a well-defined provenance 414 of the computer program 402, a holder of the certificate signature 400 can verify that the computer program 402 was written by a known and/or trusted entity. That is, the computer program provenance provides an additional layer of security to the certificate signature 400 that is secured by the public cryptographic 406.

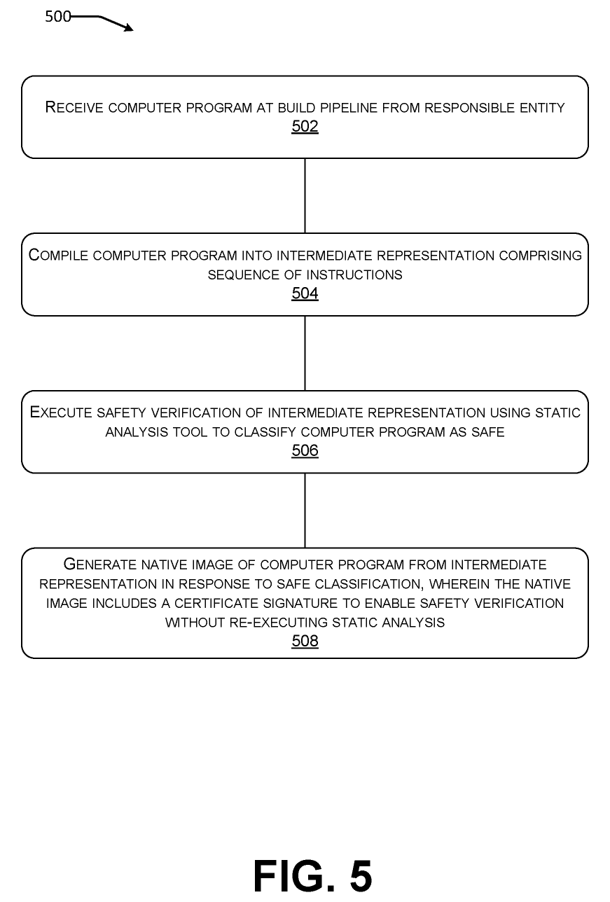

Turning now to FIG. 5, aspects of a process 500 for generating a portable proof of verification for a computer program are shown and described. With respect to FIG. 5, the process 500 begins at operation 502 where a pipeline receives a computer program from a responsible entity (e.g., a developer, an organization). As described above, the computer program can be a source code file that is formatted in a human-readable programming language such as C++ or PYTHON.

Next, at operation 504, the computer program is compiled into an intermediate representation comprising a sequence of instructions. Generally described, the intermediate representation is a reformatting of the computer program into a lower-level language prior to a machine code translation. In a specific example, the intermediate representation is a sequence of bytecode instructions. In another example, the intermediate representation is assembly code.

Then, at operation 506, a static analysis tool executes a safety verification of the intermediate representation of the computer program. As mentioned above, an intermediate representation may typically be more amenable to formal methods such as static analysis. Accordingly, the static analysis tool classifies the computer program as a safe program based on an analysis of the instructions of the intermediate representation. Generally described, a computer program is considered “safe” if it does not attempt operations that cause errors, instability, or would otherwise compromise a computing system that is executing the computer program.

Proceeding to operation 508, the build pipeline generates a native image of the computer program from the intermediate representation. As described, the native image is an executable form of the computer program comprising machine code. The machine code causes a computing system executing the native image to perform the operations defined by the instructions. In various examples, generating the native image involves translating assembly code into machine code using an assembler. Furthermore, the build pipeline includes a certificate signature with the native image. The certificate signature comprises a cryptographic key. As discussed above, machine code representations of a computer program are oftentimes not amenable to static analysis. Consequently, it may be infeasible for external entities (e.g., consumers), who do not have access to the original source code, to independently verify program safety. In this way, the certificate signature enables an external entity that receives the native image to verify the safety of the computing program without re-executing a safety verification via static analysis.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

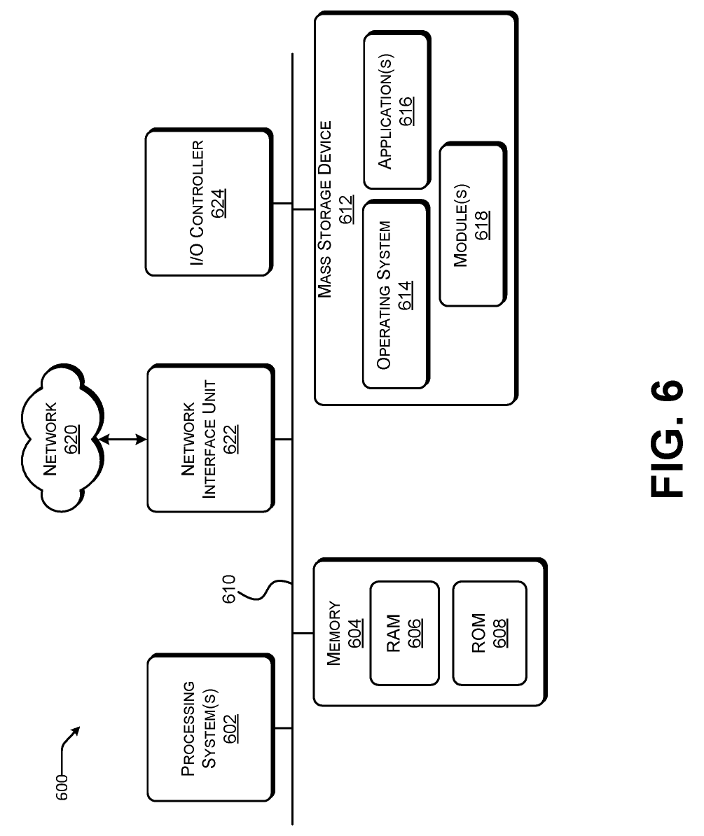

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s).

Processing unit(s), such as processing unit(s) of processing system 602, can represent, for example, a CPU-type processing unit, a GPU-type processing unit, a field-programmable gate array, another class of digital signal processor (DSP), or other hardware logic components that may, in some instances, be driven by a CPU. For example, illustrative types of hardware logic components that can be used include Application-Specific Integrated Circuits, Application-Specific Standard Products, System-on-a-Chip Systems, Complex Programmable Logic Devices, and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.

Example Clause A, a method for generating a portable proof of verification for a computer program comprising: receiving, at a build pipeline, the computer program from a responsible entity associated with the computer program; compiling, by the build pipeline, the computer program into an intermediate representation comprising a sequence of instructions; executing, by a static analysis tool, a safety verification of the intermediate representation of the computer program, wherein the static analysis tool classifies the computer program as a safe program based on an analysis of the sequence of instructions; in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

Example Clause B, the method of Example Clause A, further comprising providing the native image of the computer program to an external machine for execution, wherein: the providing enables a verification of the certificate signature against the native image of the computer program; and the verification enables a determination of a permission to execute the native image in response to determining a validity of the certificate signature based on the verifying.

Example Clause C, the method of Example Clause B, wherein a failure to verify the certificate signature prevents a loading of the native image for execution.

Example Clause D, the method of any one of Example Clause A through C, wherein the certificate signature attests that a correct version of the static analysis tool was executed on the computer program

Example Clause E, the method of any one of Example Clause A through D, wherein the certificate signature further comprises at least one of an attestation of a health status of the build pipeline, a provenance of the computer program, or a version of a toolchain.

Example Clause F, the method of any one of Example Clause A through E, wherein the certificate signature is invalidated in response to a modification to the native image.

Example Clause G, the method of any one of Example Clause A through F, wherein the certificate signature cannot be modified by the responsible entity associated with the computer program.

Example Clause H, a system for generating a portable proof of verification for a computer program comprising: a processing system; and computer-readable medium having encoded thereon, computer-readable instructions that, when executed by the processing system, causes the system to perform operations comprising: receiving, at a build pipeline, the computer program from a responsible entity associated with the computer program; compiling, by the build pipeline, the computer program into an intermediate representation comprising a sequence of instructions; executing, by a static analysis tool, a safety verification of the intermediate representation of the computer program, wherein the static analysis tool classifies the computer program as a safe program based on an analysis of the sequence of instructions; in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

Example Clause I, the system of Example Clause H, wherein: the operations further comprise providing the native image of the computer program to an external machine for execution; the providing enables a verification of the certificate signature against the native image of the computer program; and the verification enables a determination of a permission to execute the native image in response to determining a validity of the certificate signature based on the verifying.

Example Clause J, the system of Example Clause I, wherein a failure to verify the certificate signature prevents a loading of the native image for execution.

Example Clause K, the system of any one of Example Clause H through J, wherein the certificate signature attests that a correct version of the static analysis tool was executed on the computer program.

Example Clause L, the system of any one of Example Clause H through K, wherein the certificate signature further comprises at least one of an attestation of a health status of the build pipeline, a provenance of the computer program, or a version of a toolchain.

Example Clause M, the system of any one of Example Clause H through L, wherein the certificate signature is invalidated in response to a modification to the native image.

Example Clause N, the system of any one of Example Clause H through M, wherein the certificate signature cannot be modified by the responsible entity associated with the computer program.

Example Clause O, a computer-readable storage medium for generating a portable proof of verification for a computer program having encoded thereon, computer-readable instructions that, when executed by a system, cause the system to perform operations comprising: receiving, at a build pipeline, the computer program from a responsible entity associated with the computer program; compiling, by the build pipeline, the computer program into an intermediate representation comprising a sequence of instructions; executing, by a static analysis tool, a safety verification of the intermediate representation of the computer program, wherein the static analysis tool classifies the computer program as a safe program based on an analysis of the sequence of instructions; in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

Example Clause P, the computer-readable storage medium of Example Clause O, wherein: the operations further comprise, providing the native image of the computer program to an external machine for execution; the providing enables a verification of the certificate signature against the native image of the computer program; and the verification enables a determination of a permission to execute the native image in response to determining a validity of the certificate signature based on the verifying.

Example Clause Q, the computer-readable storage medium of Example Clause P, wherein a failure to verify the certificate signature prevents a loading of the native image for execution.

Example Clause R, the computer-readable storage medium of any one of Example Clause O through Q, wherein the certificate signature further comprises at least one of an attestation of a health status of the build pipeline, a provenance of the computer program, or a version of a toolchain.

Example Clause S, the computer-readable storage medium of any one of Example Clause O through R, wherein the certificate signature is invalidated in response to a modification to the native image.

Example Clause T, the computer-readable storage medium of any one of Example Clause O through S, wherein the certificate signature is inaccessible to the responsible entity associated with the computer program.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for generating a portable proof of verification for a computer program comprising:
receiving, at a build pipeline, the computer program from a responsible entity associated with the computer program;
compiling, by the build pipeline, the computer program into an intermediate representation comprising a sequence of instructions;
executing, by a static analysis tool, a safety verification of the intermediate representation of the computer program, wherein the static analysis tool classifies the computer program as a safe program based on an analysis of the sequence of instructions;
in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

2. The method of claim 1, further comprising providing the native image of the computer program to an external machine for execution, wherein:
the providing enables a verification of the certificate signature against the native image of the computer program; and
the verification enables a determination of a permission to execute the native image in response to determining a validity of the certificate signature based on the verifying.

3. The method of claim 2, wherein a failure to verify the certificate signature prevents a loading of the native image for execution.

4. The method of claim 1, wherein the certificate signature attests that a correct version of the static analysis tool was executed on the computer program.

5. The method of claim 1, wherein the certificate signature further comprises at least one of an attestation of a health status of the build pipeline, a provenance of the computer program, or a version of a toolchain.

6. The method of claim 1, wherein the certificate signature is invalidated in response to a modification to the native image.

7. The method of claim 1, wherein the certificate signature cannot be modified by the responsible entity associated with the computer program.

8. A system for generating a portable proof of verification for a computer program comprising:
a processing system; and
computer-readable medium having encoded thereon, computer-readable instructions that, when executed by the processing system, causes the system to perform operations comprising:
receiving, at a build pipeline, the computer program from a responsible entity associated with the computer program;
compiling, by the build pipeline, the computer program into an intermediate representation comprising a sequence of instructions;
executing, by a static analysis tool, a safety verification of the intermediate representation of the computer program, wherein the static analysis tool classifies the computer program as a safe program based on an analysis of the sequence of instructions;
in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

9. The system of claim 8, wherein:
the operations further comprise providing the native image of the computer program to an external machine for execution;
the providing enables a verification of the certificate signature against the native image of the computer program; and
the verification enables a determination of a permission to execute the native image in response to determining a validity of the certificate signature based on the verifying.

10. The system of claim 9, wherein a failure to verify the certificate signature prevents a loading of the native image for execution.

1111 The system of claim 8, wherein the certificate signature attests that a correct version of the static analysis tool was executed on the computer program.

12. The system of claim 8, wherein the certificate signature further comprises at least one of an attestation of a health status of the build pipeline, a provenance of the computer program, or a version of a toolchain.

13. The system of claim 8, wherein the certificate signature is invalidated in response to a modification to the native image.

14. The system of claim 8, wherein the certificate signature cannot be modified by the responsible entity associated with the computer program.

15. A computer-readable storage medium for generating a portable proof of verification for a computer program having encoded thereon, computer-readable instructions that, when executed by a system, cause the system to perform operations comprising:
receiving, at a build pipeline, the computer program from a responsible entity associated with the computer program;
compiling, by the build pipeline, the computer program into an intermediate representation comprising a sequence of instructions;
executing, by a static analysis tool, a safety verification of the intermediate representation of the computer program, wherein the static analysis tool classifies the computer program as a safe program based on an analysis of the sequence of instructions;
in response to the static analysis tool classifying the computer program as the safe program, generating a native image of the computer program from the intermediate representation, wherein the native image includes a certificate signature comprising a cryptographic key and the certificate signature enables a verification of program safety without re-execution of the safety verification by the static analysis tool.

16. The computer-readable storage medium of claim 15, wherein:
the operations further comprise, providing the native image of the computer program to an external machine for execution;
the providing enables a verification of the certificate signature against the native image of the computer program; and
the verification enables a determination of a permission to execute the native image in response to determining a validity of the certificate signature based on the verifying.

17. The computer-readable storage medium of claim 16, wherein a failure to verify the certificate signature prevents a loading of the native image for execution.

18. The computer-readable storage medium of claim 15, wherein the certificate signature further comprises at least one of an attestation of a health status of the build pipeline, a provenance of the computer program, or a version of a toolchain.

19. The computer-readable storage medium of claim 15, wherein the certificate signature is invalidated in response to a modification to the native image.

20. The computer-readable storage medium of claim 15, wherein the certificate signature is inaccessible to the responsible entity associated with the computer program.
